(19) United States
(12) Patent Application Publication
(10) Pub. No.: US 2008/0012496 A1
(43) Pub. Date: Jan. 17, 2008

(54) PLASMA DISPLAY APPARATUS

(75) Inventor: Chong-Gi HONG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/692,514

(22) Filed: Mar. 28, 2007

(30) Foreign Application Priority Data
Apr. 14, 2006 (KR) 2006-34177

(51) Int. Cl. H01J 17/49

(52) U.S. Cl. 313/587

(57) ABSTRACT

A plasma display apparatus that can reduce the failure rate of signal transmitting devices in a single scan driving method of a plasma display apparatus by reducing heat generation by the signal transmitting devices. The plasma display apparatus includes a plasma display panel that displays images using a gas discharge and comprises a plurality of address electrodes; a circuit unit that generates electrical signals to drive the plasma display panel and comprises an address driving unit that supplies electrical signals to the address electrodes; and a plurality of signal transmitting devices that transmit electrical signals received from the circuit unit to the plasma display panel and each comprises at least one electronic device. The address driving unit transmits electrical signals of single scan method to the address electrodes, and the address electrodes have a line width of 100 μm or less.

### CROSS-REFERENCE TO RELATED APPLICATIONS

This application claims the benefit of Korean Patent Application No. 2006-34177, filed on Apr. 14, 2006, in the Korean Intellectual Property Office, the disclosure of which is incorporated herein in its entirety by reference.

### BACKGROUND OF THE INVENTION

1. Field of the Invention

Aspects of the present invention relate to a plasma display apparatus, and more particularly, to a plasma display apparatus that can improve heat dissipation of signal transmitting devices driven by a single scan method.

2. Description of the Related Art

A Plasma display apparatus is a flat panel display device that displays images using a gas discharge phenomenon in which a plurality of electrodes excite a discharge gas sealed in discharge cells. The discharge gas emits ultraviolet photons, which in turn, excite electrons of phosphors disposed in the discharge cells. The excited electrons emit visible light when the electrons return to a previous energy state. The discharge cells are arranged in a predetermined pattern so that an image can be displayed. Recently, such displays have received attention as, when compared to other flat display devices, the flat panel devices have superior characteristics such as large screen size, high image quality, ultra-thin and light weight design, large viewing angle, and simple manufacturing process.

Conventionally, a plasma display apparatus includes a plasma display panel (PDP), a chassis substantially disposed parallel to support the PDP, a circuit unit mounted on the rear of the chassis to drive the PDP, and a case that accommodates the PDP, the chassis, and the circuit unit.

In the plasma display apparatus having the above configuration, the circuit unit and the PDP are electrically connected to each other by a signal transmitting device such as a tape carrier package (TCP) or a chip on film (COF). The TCP is formed, for example, by mounting electronic devices, such as ICs, on a tape or a tape shaped device. The COF is formed by mounting devices on a film that comprises a flexible printed circuit. Since the TCP and COF are flexible and include a plurality of devices, the TCP and COF are widely used to reduce the size of the circuit unit that drives the plasma display apparatus.

However, the signal transmitting devices such as the TCP and COF generate heat from the devices mounted thereon while driving the PDP. In particular, a high definition (HD) single scan driving method generates a larger amount of heat from the signal transmitting devices connected to a single address driving unit than an HD dual scan driving method. In the dual scan method, an address current enters the PDP from the signal transmitting devices on two sides of the PDP, but in the single scan method, an address current enters the PDP from the signal transmitting devices located on only one side of the PDP. Thus, in the single scan driving method, the address current entering the PDP has an intensity of approximately twice the intensity of the address current entering the PDP in the double scan driving method. Accordingly, the circuit terminals of the signal transmitting devices of the single scan driving method receive a greater amount of current than the signal transmitting devices of the duel scan driving method. Therefore, TCP breakage due to high heat generation of the TCP is problematic.

### SUMMARY OF THE INVENTION

Aspects of the present invention provide a plasma display apparatus that can reduce the rate of failure of signal transmitting devices in a single scan driving method by reducing the temperature of the signal transmitting devices.

According to an aspect of the present invention, there is provided a plasma display apparatus comprising: a plasma display panel that displays images using a gas discharge and comprises a plurality of address electrodes; a circuit unit that generates electrical signals to drive the plasma display panel and comprises an address driving unit that supplies electrical signals to the address electrodes; and signal transmitting devices that transmit electrical signals received from the circuit unit to the plasma display panel and each signal transmitting device comprises at least one electronic device, wherein the address driving unit transmits electrical signals of a single scan driving method to the address electrodes, and the address electrodes have a line width of 100 μm or less.

The address electrodes may have a line width between about 40 μm and 100 μm.

The signal transmitting devices may comprise TCPs (tape carrier packages) or COFs (chip on films).

The signal transmitting devices may be located on a side of the plasma display panel.

The temperature of the signal transmitting devices during driving of the plasma display panel may be about 70° C. or less.

The address electrodes may extend in a stripe or elongated narrow strip shape from a side of the plasma display panel to an opposite side of the plasma display panel.

The address electrodes may be formed of a material selected from the group consisting of ITO, IZO, In₂O₃, and ZnO.

The plasma display panel may comprise: a front substrate; a rear substrate disposed at a predetermined distance from the front substrate to face the front substrate and that defines a plurality of discharge cells between the front substrate and the rear substrate; sustain electrode pairs that generate discharges in the discharge cells; address electrodes that extend to cross the sustain electrode pairs; and phosphor layers disposed in the discharge cells.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating a plasma display apparatus according to aspects of the present invention;

FIG. 2 is a partial cutaway exploded perspective view illustrating the plasma display panel according FIG. 1;

FIG. 3 is a block diagram illustrating the driving of the circuit unit of FIG. 1;

FIG. 4 is a schematic plan view illustrating the structure of a PDP having high definition single scan address scanning; and

FIG. 5 is a schematic plan view illustrating the structure of a PDP having high definition dual scan address scanning PDP.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

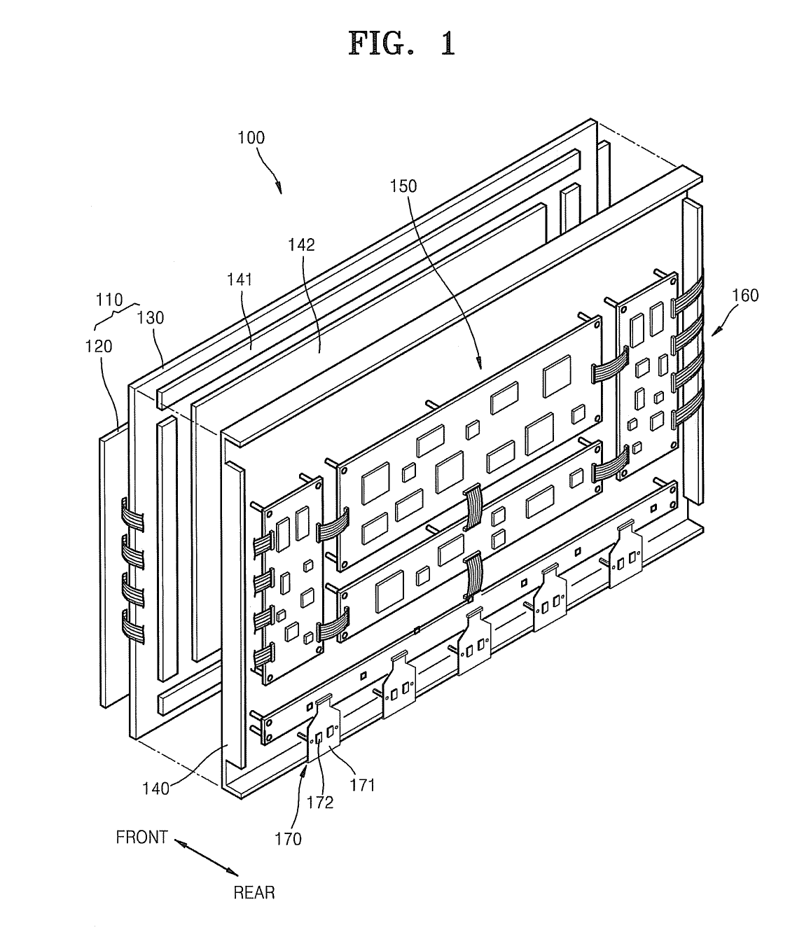

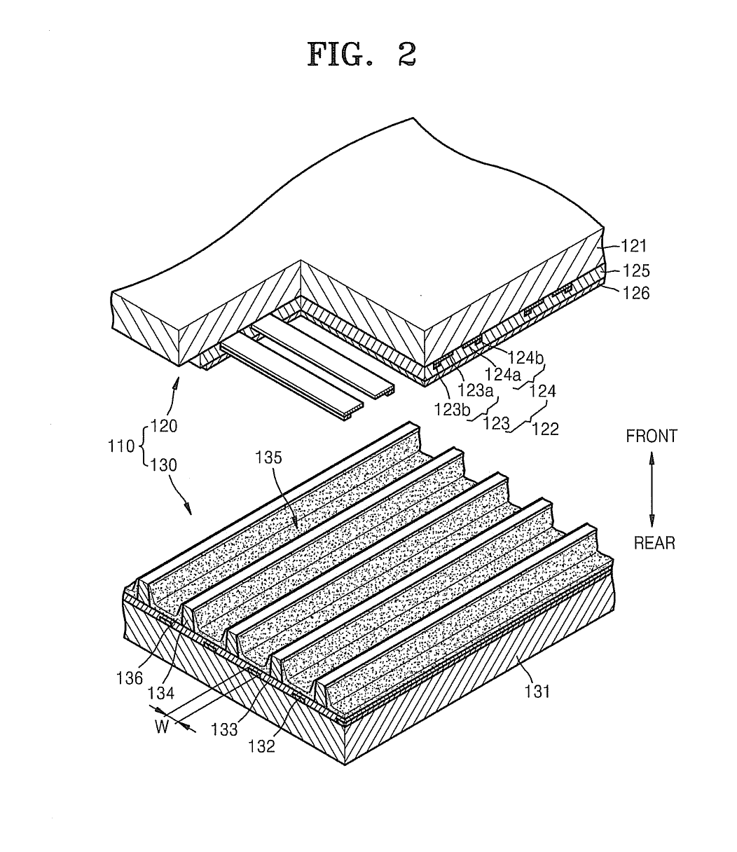

FIG. 1 is an exploded perspective view illustrating a plasma display apparatus 100 according to aspects of the present invention. FIG. 2 is a partial cutaway exploded perspective view illustrating a plasma display panel 110 of FIG. 1. Referring to FIG. 1, the plasma display apparatus 100 includes the plasma display panel (PDP) 110 that displays images using a gas discharge as described above. The PDP 110 can be one of various PDPs. For example, as depicted in FIG. 2, the PDP 110 can be an alternating current type PDP with a surface discharge type three-electrode structure. However, the PDP 110 is not limited thereto.

The chassis 140, which can be manufactured by a casting or a press process, supports the PDP 110 and a circuit unit 150. The chassis 140 can be formed of a metal having high thermal conductivity, such as aluminum, to effectively dissipate heat transmitted from the PDP 110 away therefrom. Also, the chassis 140 can have a structure in which edges of the chassis 140 are bent toward a rear side of the chassis 140 so that the chassis 140 can have an increased strength and resist being bent or twisted. The chassis 140 and the PDP 110 are coupled using a double sided tape 141.

A thermal conductive sheet 142 having a high thermal conductivity is disposed between the PDP 110 and the chassis 140. The thermal conductive sheet 142 dissipates heat locally generated by the PDP 110, and transmits a portion of heat generated by the PDP 110 to the chassis 140. The thermal conductive sheet 142 can be a silicon glass sheet, a silicon heat dissipation sheet, an acryl group heat dissipation pressure reduction adhesive sheet, a urethane group heat dissipation pressure reduction adhesive sheet, or a carbon sheet.

Also, the signal transmitting devices of the plasma display apparatus 100 are FPCs 160 and located on the left side and the right side of the chassis 140. Another signal transmitting device is a wiring unit 171 having a tape shape and located on a lower side of the chassis 140. Each of the TCPs 170 includes at least one electronic device 172. As depicted in FIG. 1, the TCPs 170 are disposed at a predetermined distance from each other TCP 170 along a lower side of the chassis 140.

Referring to FIG. 2, the PDP 110 includes a front panel 120 and a rear panel 130 which faces the front panel 120 and is coupled to the front panel 120. The front panel 120 includes a front substrate 121 and sustain electrode pairs 122 that are formed on a rear surface of the front substrate 121 to be disposed between the front substrate 121 and the rear panel 130. Each sustain electrode pairs 122 includes an X electrode 123 and a Y electrode 124. A front dielectric layer 125 covers the sustain electrode pairs 122, and a protective layer 126, usually formed of MgO, is formed on a rear surface of the front dielectric layer 125. The X electrode 123 and the Y electrode 124 function as a common electrode and a scan electrode, respectively. The X electrode 123 and the Y electrode 124 are separated from each other by a discharge gap. The X electrode 123 includes an X transparent electrode 123a and an X bus electrode 123b formed to be connected to the X transparent electrode 123a. The Y electrode 124 also includes a Y transparent electrode 124a and a Y bus electrode 124b formed to be connected to the Y bus electrode 124a.

The rear panel 130 includes a rear substrate 131. Address electrodes 132 are formed on the front surface of the rear substrate 131 and extend in a direction that crosses the sustain electrode pairs 122. A rear dielectric layer 133 covers the address electrodes 132, and barrier ribs 134 are formed on the rear dielectric layer 133 to define a plurality of discharge cells 135. Phosphor layers 136 are disposed in the discharge cells 135. A discharge gas is filled in the discharge cells 135. The address electrodes 132 can be a transparent electrode, and can be formed of a material selected from the group consisting of ITO, IZO, In₂O₃, and ZnO. However, the address electrodes 132 are not limited thereto, but can be formed of various conductive materials such as Al, Ag, or Cu.

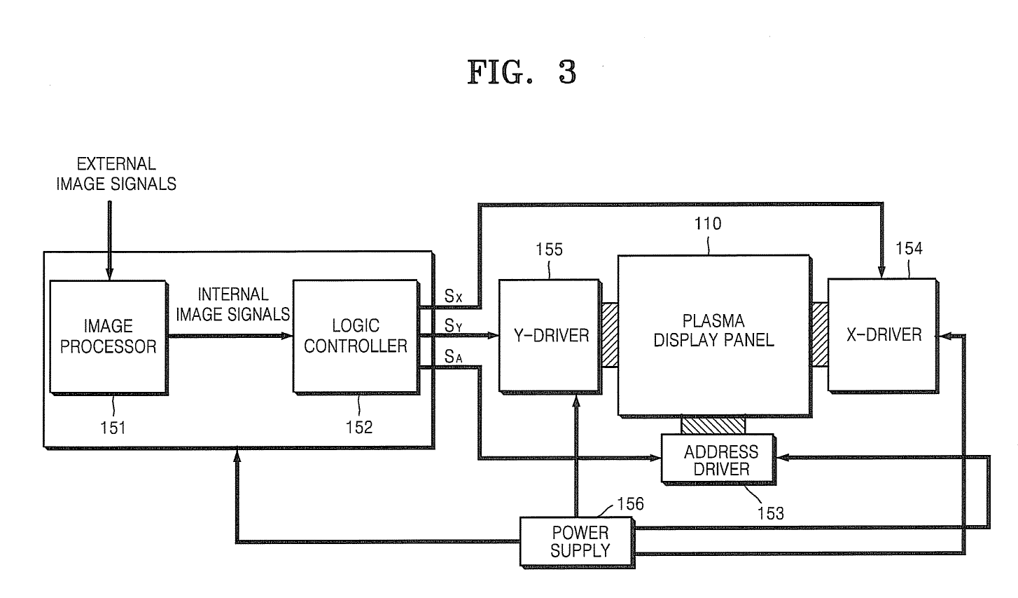

The circuit unit 150 is mounted on the rear of the chassis 140 to drive the PDP 110, and includes a plurality of various electronic parts. FIG. 3 is a block diagram illustrating the driving of the circuit unit 150 of FIG. 1. Referring to FIG. 3, the circuit unit 150 of FIG. 1 can include an image processing unit 151, a logic control unit 152, an address driving unit 153, an X driving unit 154, a Y driving unit 155, and a power supply unit 156. The image processing unit 151 generates internal image signals, for example, respectively 8 bits of red, green, and blue image data, a clock signal, vertical and horizontal synchronized signals. The image processing unit 151 generates the internal signals by transforming an external analog image signal to a digital signal. The logic control unit 152 generates driving control signals S_{A}, S_{Y}, and S_{X} according to the internal image signals received from the image processing unit 151. The address driving unit 153 generates a display data signal by processing the address driving control signal S_{A} of the driving control signals S_{A}, S_{Y}, and S_{X} received from the logic control unit 152 and applies the generated display data signal to the address electrodes 132. The X driving unit 154 processes the X driving control signal S_{X} of the driving signals S_{A}, S_{Y}, and S_{X} received from the logic control unit 152 and applies it to the X electrodes 123 of the PDP 110. The Y driving unit 155 processes the Y driving control signal S_{Y} of the driving control signals S_{A}, S_{Y}, and S_{X} received from the logic control unit 152 and applies it to the Y electrodes 124 of the PDP 100. The power supply unit 156 generates and supplies operating voltages required for driving the image processing unit 151, the logic control unit 152, the address driving unit 153,.the X driving unit 154, and the Y driving unit 155.

The circuit unit 150 transmits electrical signals to the PDP 110 through the signal transmitting devices. The signal transmitting devices can be flexible printed cables (FPCs), tape carrier packages (TCPs), or chip on films (COFs). In FIG. 1, the signal transmitting devices are FPCs 160 and located on the left side and the right side of the chassis 140. Another signal transmitting device is a wiring unit 171 having a tape shape and located on a lower side of the chassis 140. Each of the TCPs 170 includes at least one electronic device 172. As depicted in FIG. 1, the TCPs 170 are disposed at a predetermined distance from each other TCP 170 along a lower side of the chassis 140.

The circuit unit 150 is formed to drive the PDP 110 using a high definition (HD) single scan driving method. The TCPs 170 transmit electrical signals generated by the address driving unit 153 of the circuit unit 150 to the address electrodes 132. That is, one end of each of the TCPs 170 is electrically connected to the address electrode 132 disposed in the PDP 110 via the lower edge of the chassis 140, and the other end of each of the TCPs 170 is connected to the address driving unit 153 of the circuit unit 150. Each of the TCPs 170 includes two electronic devices 172, such as address driving ICs, and the electronic devices 172 are disposed on a rear surface of the chassis 140 near the lower edge of the chassis 140. The signal transmitting device that connects the address electrodes 132 to the address driving unit 153 can be the TCP 170 as depicted in FIG. 1, but the TCP 170 is not limited thereto. The COF or the FPC may also be used.

As the PDP 110 is driven by a HD single scan driving method, the TCPs 170 are connected to the PDP 110 on one side, that is, the lower side of the PDP 110.

The address electrodes 132 connected to the TCPs 170 extend in a stripe or elongated narrow strip shape from the lower side of the PDP 110 to the other side of the PDP 110.

In the HD single scan structure, the address electrodes 132 are formed to have a width of 40 to 100 μm, which reduces heat generation by the TCPs 170.

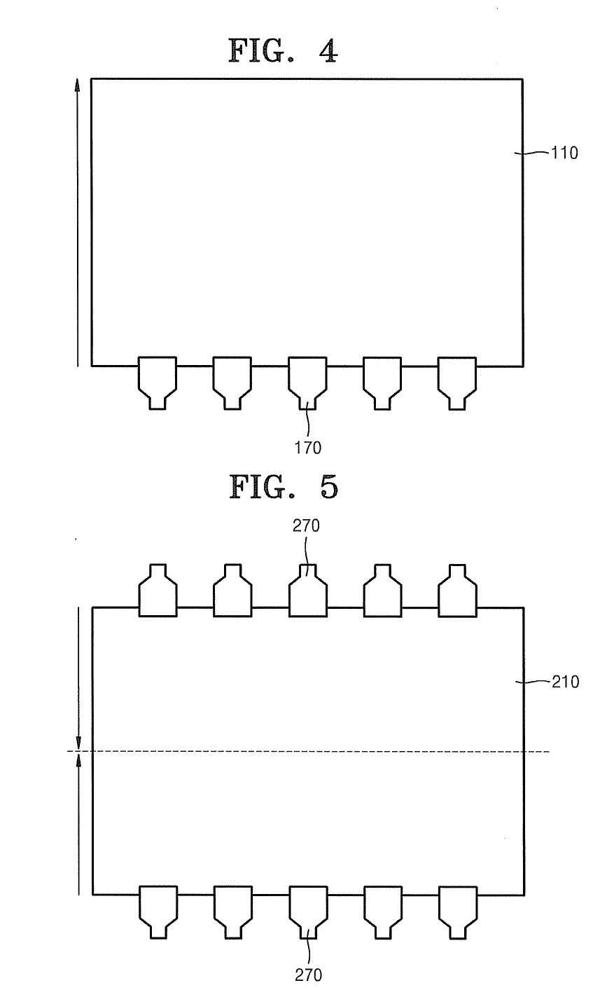

FIG. 4 is a schematic plan view illustrating the structure of a PDP 110 having HD single scan address scanning, and FIG. 5 is a schematic plan view illustrating the structure of a PDP 210 having HD dual scan address scanning. Referring to FIG. 4, in the HD single scan structure, the TCPs 170 are disposed on a lower side of the PDP 110, and the scan is performed in a direction indicated by the arrow such that the scan progresses from the lower side of the PDP 110 to the upper or opposite side of the PDP 110. However, in the HD dual scan structure as depicted in FIG. 5, TCPs 270 are disposed on upper and lower sides of the PDP 210, and the scan is performed in both upward and downward directions as indicated by the arrows such that the scan progresses from the TCPs 270 disposed near the upper side of the PDP 210 toward the middle of the PDP 210 and from the TCPs 270 disposed near the lower side of the PDP 210 toward the middle of the PDP 210.

Power is proportional to the square of the current in the TCPs 170 and 270 when the address voltage for discharge is constant. In the case of the HD dual scan structure of FIG. 5, the address current is divided. However, in the HD single scan structure of FIG. 4, the address current is not divided. Therefore, the TCPs 170 receive much greater power than the TCPs 270. Table 1 summarizes the comparison of address current, power consumption, power consumption per TCP IC, and temperature of the TCP IC of 42 inch plasma display apparatuses having HD single and HD dual scan structures. The measurements were performed using a 2 dot on-off pattern in which on and off states of two cells are alternately repeated. In this pattern, the maximum load and current for addressing are applied to the cells due to large switching. For the measurement, the widths of address electrodes of both the HD single and HD dual scan structures were 150 μm.

TABLE 1

| | | | | Power | |
|---|---|---|---|---|---|
| HD Scan | Address | Address | Power | consumption | IC |
| structure | voltage | current | consumption | per TCP IC | temperature |
| Single | 65 V | 3.01 A | 117 W | 3.6 W | 85° C. |
| scan | | | | | |
| Dual scan | 65 V | 1.74 A | 75 W | 1.2 W | 63° C. |

Referring to Table 1, in the case of HD single scan structure, the temperature of the TCP IC exceeded 70° C., and failure due to breakage of the TCPs occurred.

Therefore, the amount of address current supplied to the TCPs 170 was reduced by reducing the line width W of the address electrodes. Accordingly, the heat generation by the TCPs 170 was reduced by reducing the power consumption of the TCPs 170.

Table 2 summarizes temperature variation of TCP IC according to line width W of an address electrode in a 42 inch plasma display apparatus having an HD single scan structure. The measurements were performed using the 2 dot on-off pattern.

TABLE 2

| | | | TCP breakage |
|---|---|---|---|
| | Width of address | | failures |
| Address voltage | electrode | IC temperature | (sheets) |
| 65 V | 150 μm | 85° C. | 90/100 |
| 65 V | 120 μm | 75° C. | 50/100 |
| 65 V | 110 μm | 72° C. | 20/100 |
| 65 V | 100 μm | 68° C. | 0/100 |
| 65 V | 90 μm | 64° C. | 0/100 |

Referring to Table 2, when the line width W of the address electrode is smaller than 100 μm, the temperature of the TCP IC is lower than 70° C., and thus, the TCP breakage failure is substantially decreased. The line width W of the address electrode may be about 40 μm. The manufacture of the address electrode having a line width less than 40 μm is difficult due to process limitations.

According to aspects of the present invention, the heat generation of the signal transmitting devices connected to the address electrodes can be substantially decreased in a plasma display apparatus using an HD single scan driving method, and accordingly, the failure rate of the signal transmitting devices can be greatly decreased.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display apparatus, comprising:
a plasma display panel that displays images using a gas discharge and comprises a plurality of address electrodes;
a circuit unit that generates electrical signals to drive the plasma display panel and comprises an address driving unit that supplies electrical signals to the address electrodes; and
signal transmitting devices that transmit electrical signals received from the circuit unit to the plasma display panel and each signal transmitting device comprises at least one electronic device,
wherein the address driving unit transmits electrical signals of a single scan driving method to the address electrodes, and the address electrodes have a line width of 100 μm or less.

2. The plasma display apparatus of claim 1, wherein the address electrodes have a line width between about 40 μm and 100 μm.

3. The plasma display apparatus of claim 1, wherein the signal transmitting devices comprise tape carrier packages or chip on films.

4. The plasma display apparatus of claim 1, wherein the signal transmitting devices are located on a side of the plasma display panel.

5. The plasma display apparatus of claim 1, wherein temperatures of the signal transmitting devices during driving of the plasma display panel is about 70° C. or less.

6. The plasma display apparatus of claim 1, wherein the address electrodes extend in a stripe shape from a side of the plasma display panel to an opposite side of the plasma display panel.

7. The plasma display apparatus of claim 1, wherein the address electrodes are formed of a material selected from the group consisting of ITO, IZO, In₂O₃, and ZnO.

8. The plasma display apparatus of claim 1, wherein the plasma display panel comprises:
a front substrate;
a rear substrate disposed at a predetermined distance from the front substrate to face the front substrate and that defines a plurality of discharge cells between the front substrate and the rear substrate;
sustain electrode pairs that generate discharges in the discharge cells;
address electrodes that extend to cross the sustain electrode pairs; and
phosphor layers disposed in the discharge cells.
